(19) United States
(12) Patent Application Publication
(10) Pub. No.: US 2024/0117894 A1
(43) Pub. Date: Apr. 11, 2024

(54) VALVE DEVICE

(71) Applicant: MIKUNI CORPORATION, Tokyo (JP)

(72) Inventors: Yuuhei SANEKATA, Odawara-shi (JP); Keigo SUZUKI, Odawara-shi (JP)

(73) Assignee: MIKUNI CORPORATION, Tokyo (JP)

(21) Appl. No.: 18/477,025

(22) Filed: Sep. 28, 2023

(30) Foreign Application Priority Data
Oct. 6, 2022 (JP) 2022-161431
Aug. 1, 2023 (JP) 2023-125691

(51) Int. Cl. F16K 31/53; F02D 9/10

(52) U.S. Cl. CPC F16K 31/535; F02D 9/1065; F16K 1/221

(57) ABSTRACT

A valve device includes a drive gear made of a resin at one end of the valve shaft and includes a detection target of an inductive sensor in the drive gear, the drive gear includes a lever member made of metal and integrated along with the detection target through insert molding in a state where a center portion is exposed in one side surface, an exposure portion of the lever member in the drive gear and the end of the valve shaft are caused to abut each other and rear surfaces of the abutting portions are fixed through laser welding through the outer hole to configure a valve shaft unit, and the lever member is provided with an arc hole extending in a circumferential direction on a radially outer side of the position of the welding with the end of the valve shaft.

### BACKGROUND OF THE INVENTION

### Field of the Invention

The present invention relates to a fixation structure between a valve shaft and a gear in a valve device.

### DESCRIPTION OF THE RELATED ART

Many valves such as throttle valves have a configuration in which a flow path is formed in a housing, a valve body that opens and closes the flow path is fixed to a valve shaft, and the valve shaft is driven by a rotation actuator such as an electric motor. A decelerator is included between the rotation actuator and the valve shaft, and the valve shaft includes a drive gear as a part of the decelerator.

A valve device described in Japanese Patent Laid-Open No. 2014-105691, for example, has a configuration in which a valve shaft is inserted into and fixed to a hole portion provided in a drive gear, and the valve shaft and the drive gear are fixed such that a rotation drive force can be transmitted between the valve shaft and the drive gear by forming the section of the valve shaft and the hole portion in the drive gear into rectangular shapes, for example, and fastening them with a nut at an attachment portion of the valve shaft and the drive gear.

Here, fixing the valve shaft and the drive gear through welding, for example, to simplify the attachment structure between the valve shaft and the drive gear is conceivable.

In a case where the drive gear is made of a resin, the drive gear and the valve shaft made of metal cannot be welded. Thus, it is considered that a structure in which a support made of metal is incorporated in advance in the drive gear through insert molding working or the like is employed and the support and the valve shaft made of metal are fixed through welding with a laser or the like. However, there is a concern that a part of the drive gear around the welded part may be deformed due to heat when the support and the valve shaft are welded in the drive gear including the support made of metal through the insert molding.

The present invention was made in view of such a problem, and an object thereof is to provide a valve structure with a structure that reduces a thermal influence on a drive gear when the drive gear and a valve shaft are fixed through welding.

### SUMMARY OF THE INVENTION

In order to achieve the above object, a valve device according to the present invention includes: a plate-shaped gear made of a resin at one end of a shaft made of metal driving a valve body, the gear has a support member made of metal and integrated through insert molding in a state where at least a part of the support member is exposed in one side surface, an exposure portion of the support member in the gear and the end of the shaft are welded to configure a shaft unit, and the support member is provided with a hole portion extending in a circumferential direction on a radially outer side of a position of welding with the end of the shaft.

Preferably, the hole portion is a hole into which a protruding portion of a mold die of the gear is inserted such that the support member is held at the time of the insert molding working.

Preferably, the protruding portion protrudes on a distal side in an insertion direction through the support member and partitions between a radially outer side and a radially inner side of the protruding portion in a state the protruding portion is inserted into the hole portion at the time of the insert molding working.

Preferably, a detection target of a non-contact sensor detecting a rotation angle of the shaft is included on a side of the other side surface of the gear and the detection target is integrated into the gear along with the support member through the insert molding.

Preferably, the protruding portion of the mold die penetrating through the support member supports the detection target at the time of the insert molding working.

Preferably, the valve device is a throttle valve controlling an amount of air intake of an internal combustion engine.

According to the valve device of the present invention, the gear fixed to the shaft driving the valve body is insert-molded to include the support member made of metal. Also, the exposure portion of the support member in the gear including the support member and the end of the shaft are welded to configure the shaft unit.

Furthermore, since the support member is provided with the hole portion extending in the circumferential direction on the radially outer side of the position of the welding with the end of the shaft, welding heat is unlikely to be transmitted from the welding position on the radially inner side of the hole portion to the radially outer side when the support member and the shaft are welded. Therefore, heat is unlikely to be transmitted to the gear portion located further outward in the radial direction than the hole portion at the time of the welding between the support member and the shaft, and it is possible to reduce thermal deformation of the gear made of a resin.

### BRIEF DESCRIPTION OF THE DRAWINGS

FIG. 1 is a perspective view of a valve device according to an embodiment of the present invention;

FIG. 2 is a vertical sectional view of the valve device according to the embodiment;

FIG. 3 is a perspective view of a valve shaft unit;

FIG. 4 is a diagram illustrating components of a drive gear in the valve shaft unit;

FIG. 5 is a perspective view of the drive gear in the valve shaft unit;

FIG. 6 is a perspective view of the drive gear and a valve shaft in the valve shaft unit;

FIG. 7 is an explanatory diagram illustrating a method for fixing the drive gear and the valve shaft;

FIG. 8 is an explanatory diagram illustrating a positional relationship between a lever member and a detection target;

FIG. 9 is a front view illustrating a shape of the lever member; and

FIG. 10 is an explanatory diagram of a method for manufacturing the drive gear.

### DETAILED DESCRIPTION OF THE INVENTION

Hereinafter, an embodiment of the present invention will be described on the basis of the drawings.

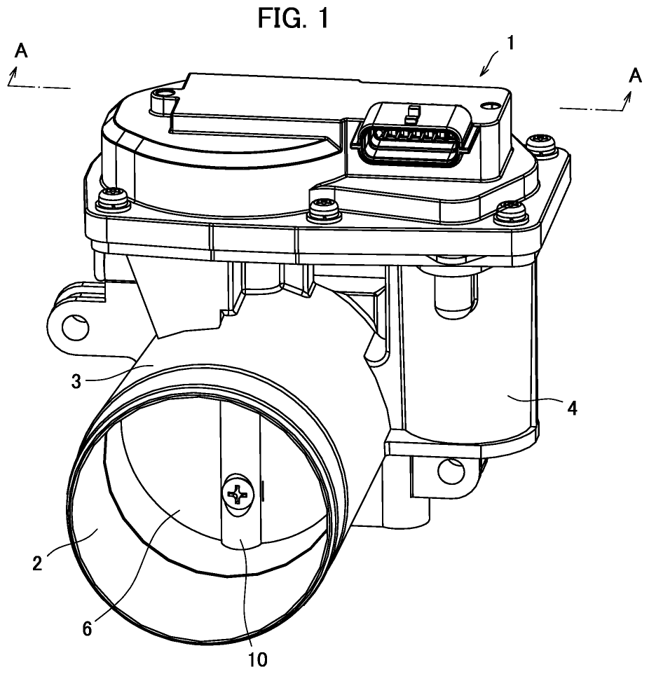

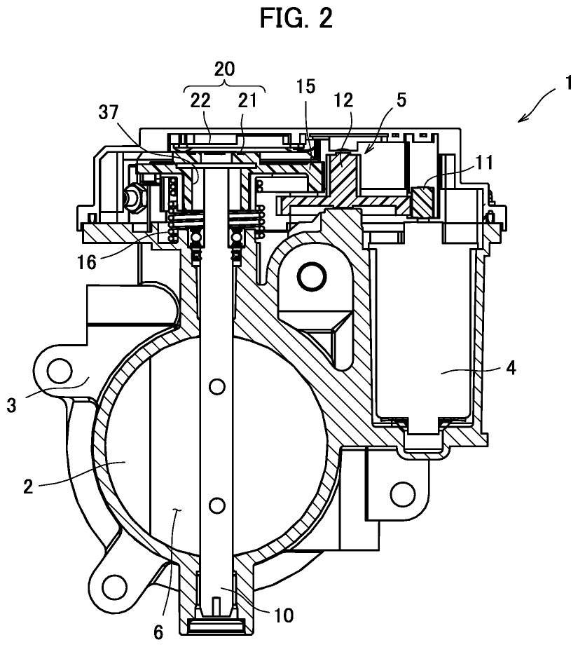

FIG. 1 is a perspective view of a valve device 1 according to an embodiment of the present invention. FIG. 2 is a vertical sectional view of the valve device 1 according to the embodiment. Note that FIG. 2 is a sectional view along the A-A part illustrated in FIG. 1.

The valve device 1 according to the embodiment of the present invention is, for example, a throttle valve and is placed in an intake passage of an internal combustion engine to control the amount of air intake.

As illustrated in FIGS. 1 and 2, the valve device 1 includes an electric motor 4 and a decelerator 5 in a casing 3 with a fluid passage 2 as a part of the intake passage formed therein. The valve device 1 includes a valve body 6 that opens and closes the fluid passage 2 and a valve shaft 10 (shaft) rotatably supported by the casing 3 and disposed to traverse the fluid passage 2. The valve body 6 is fixed to the valve shaft 10.

The decelerator 5 is configured of a motor gear 11 fixed to an output shaft of the electric motor 4, an intermediate gear 12 rotatably supported by the casing 3, and a drive gear 15 (gear) fixed to an end of the valve shaft 10, and power is transmitted from the electric motor 4 to the motor gear 11, the intermediate gear 12, and the drive gear 15 in order to drive and rotate the valve shaft 10.

A return spring 16 is included to be adjacent to the drive gear 15 in the vicinity of the one end of the valve shaft 10. The return spring 16 is a torsion coil spring wound around the valve shaft 10 and has one end locked at the drive gear 15 and the other end locked at the casing 3. The return spring 16 biases the valve shaft 10 in one rotation direction.

The casing 3 includes two stoppers that are not illustrated and abut the drive gear 15. The stoppers limit the rotation angle of the valve shaft 10 within a range of a predetermined angle (90 degrees, for example).

When power is not distributed to the electric motor 4, the valve shaft 10 is rotated by a biasing force of the return spring 16, and the fluid passage 2 is fully closed (or fully opened) by the valve body 6. The valve shaft 10 is rotated against the biasing force of the return spring 16 by distributing power to the electric motor 4, and the amount of air intake flowing through the fluid passage 2 is adjusted by the valve body 6 rotating.

An inductive sensor 20 (non-contact sensor) that detects a rotation angle (rotation position) of the valve shaft 10 is included at one end of the valve shaft 10 on the side of the drive gear 15.

The inductive sensor 20 includes a detection target 21 provided at the drive gear 15 and made of metal and a sensor main body 22 fixed to the casing 3 and disposed near the detection target 21 to face it.

The sensor main body 22 of the inductive sensor 20 includes, for example, a sensor coil, generates a high-frequency magnetic field by causing a current to flow through the sensor coil, detects inductance of the sensor coil that is changed by the detection target moving in the magnetic field, and thereby detects a rotation angle of the valve shaft 10.

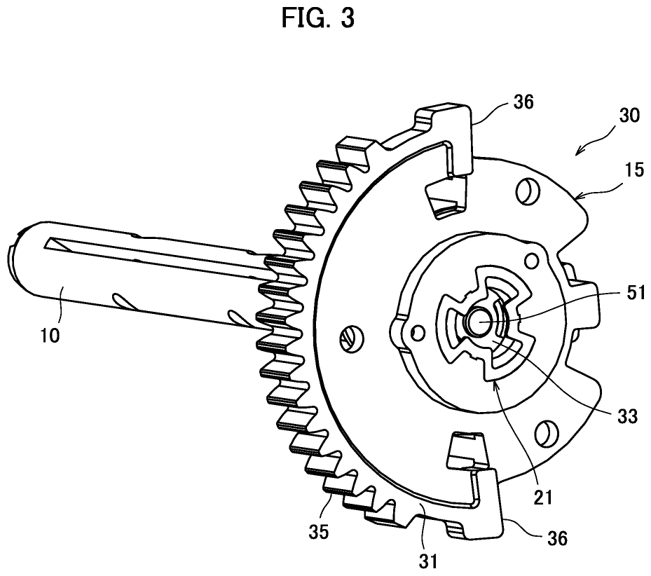

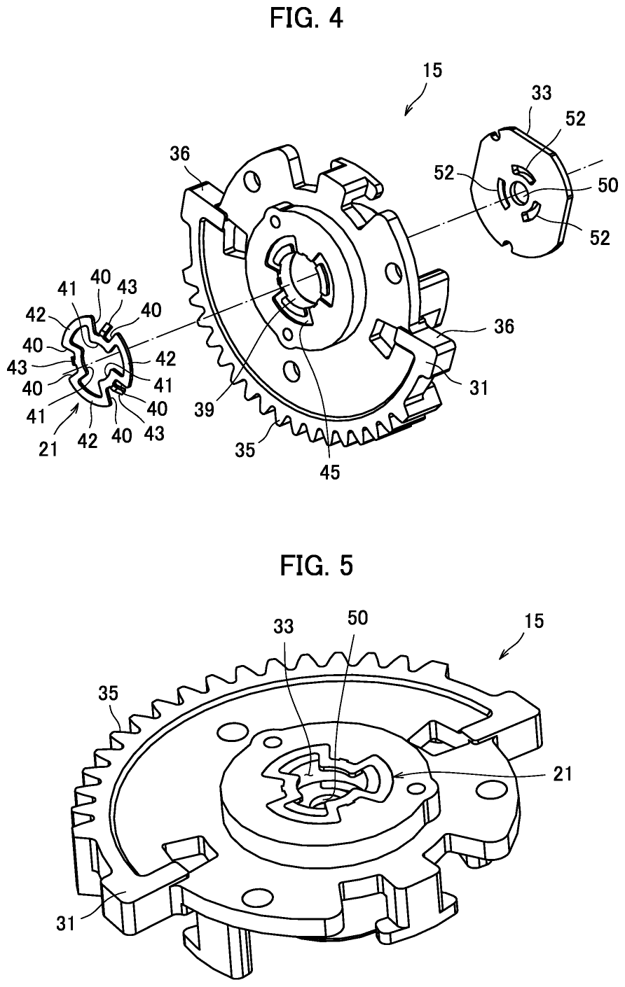

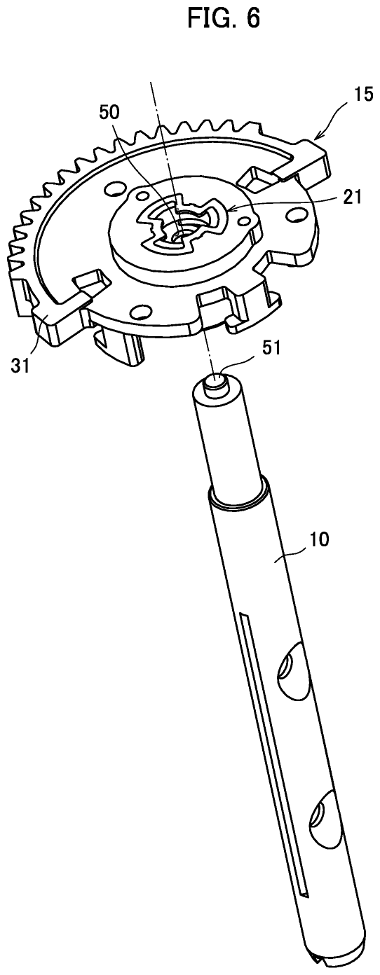

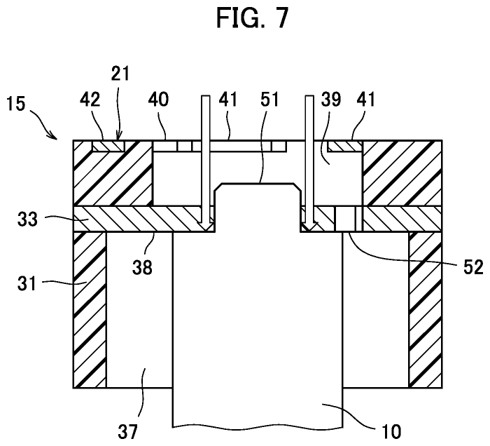

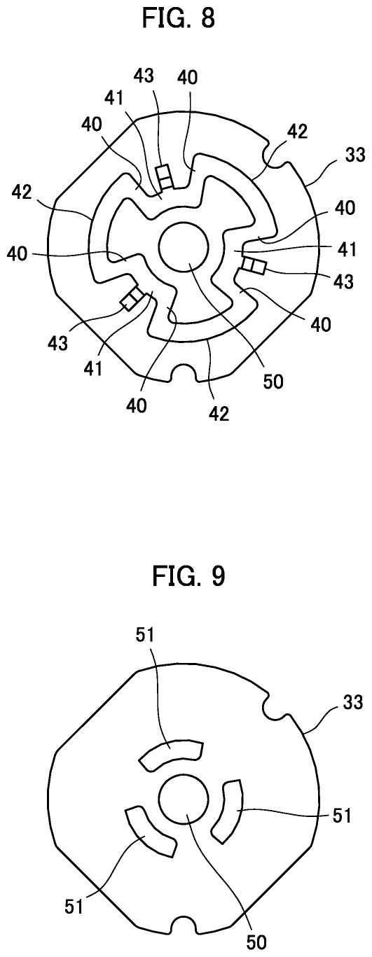

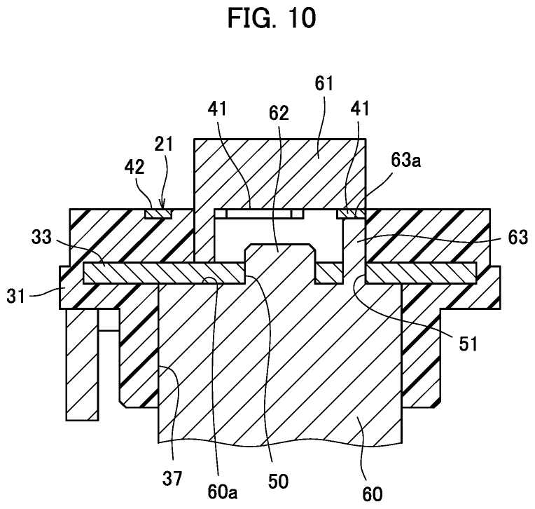

FIG. 3 is a perspective view of a valve shaft unit 30. FIG. 4 is a diagram illustrating components of the drive gear 15 in the valve shaft unit 30. FIG. 5 is a perspective view of the drive gear 15 in the valve shaft unit 30. FIG. 6 is a perspective view of the drive gear 15 and the valve shaft 10 in the valve shaft unit 30. FIG. 7 is an explanatory diagram illustrating a method for fixing the drive gear 15 and the valve shaft 10. Note that FIG. 7 is a vertical sectional view of a part where the drive gear 15 and he valve shaft 10 are fixed. FIG. 8 is an explanatory diagram illustrating a positional relationship of the detection target with respect to a lever member. FIG. 9 is a front view illustrating a shape of the lever member. FIG. 10 is an explanatory diagram of a method for manufacturing the drive gear 15. Note that FIG. 10 is a vertical sectional view passing through a center hole of the lever member.

As illustrated in FIGS. 3 and 4, the valve shaft unit 30 is configured of the valve shaft 10 and the drive gear 15 made of metal. The drive gear 15 is configured of a gear portion 31 made of a resin, the detection target 21 of the inductive sensor 20, and a lever member 33 (support member) made of metal.

The gear portion 31 is a component with a substantially disk shape formed of a resin, and a gear 35 (for example, a spur gear) is formed over a substantially half (about 180 degrees) of an outer circumferential end thereof. Stopper abutting surfaces 36 that abut the stoppers that are included in the casing 3 and are not illustrated to limit rotation are provided at both ends of the outer circumferential portion in the circumferential direction where the gear 35 is formed. A circular shaft attachment hole 37 (insertion hole) into which the valve shaft 10 is inserted is included (see FIG. 7) is included at the center of an inner surface of the gear portion 31 (the surface on the side opposite to the surface facing the sensor main body 22; one side surface in the present invention). Note that the shaft attachment hole 37 has a diameter that is slightly larger than the outer diameter of the valve shaft 10. The center portion of the lever member 33 is exposed to the inside of the shaft attachment hole 37 (an exposure portion 38 illustrated in FIG. 7).

An outer hole 39 (exposure hole) with a diameter that is smaller than the shaft attachment hole 37 and is larger than the valve shaft 10 is included at the center of the outer surface of the gear portion 31 (the surface facing the sensor main body 22; the other side surface in the present invention). The outer hole 39 and the shaft attachment hole 37 penetrate through the center of the gear portion 31.

The detection target 21 has six radial-direction members 40 having substantially disk shapes of thin plates hollowed out at the centers and extending in the radial direction, three inner circumferential-direction members 41 extending in the circumferential direction and coupling ends of the radial-direction members 40 on the center side, and three outer circumferential-direction members 42 extending in the circumferential direction and coupling ends of the radial-direction members 40 on the outer side. All the radial-direction members 40, the inner circumferential-direction members 41, and the outer circumferential-direction members 42 have widths and thicknesses of about several mm. The radial-direction members 40 are disposed at equal intervals in the circumferential direction, ends thereof on the center side are coupled to one every two inner circumferential-direction members 41, and ends thereof on the outer side are coupled to one every two the outer circumferential-direction members 42 with deviation from the inner circumferential-direction member 41 in the circumferential direction. Claw portions 43 for positioning the detection target 21 are included in the inner circumferential-direction members 41 of the detection target 21. The claw portions 43 are provided at circumferential-direction intermediate positions of the outer circumference-side ends of the inner circumferential-direction members 41, have widths and projection lengths of about 1 to 2 mm, and are bent perpendicularly to the inner circumferential-direction members 41.

The detection target 21 is disposed coaxially with the center of the gear portion 31 on the outer surface of the gear portion 31 on the side of the outer hole 39. Also, the surfaces of the inner circumferential-direction members 41 of the detection target 21 on the radially outer side and the outer edges of the outer hole 39 of the gear portion 31 are located at substantially the same positions in the radial direction.

Grooves 45 that accommodate the outer circumferential-direction members 42 and the radial-direction members 40 are formed in the surface of the gear portion 31 on the outer side.

The lever member 33 is made of metal, has a flat plate shape, and is buried inside the gear portion 31. A circular center hole 50 that is smaller than the outer diameter of the valve shaft 10 opens at the center of the lever member 33. Note that a columnar projecting portion 51 projecting in the axial direction is included at one end of the valve shaft 10, and the projecting portion 51 is inserted into the center hole 50 of the lever member 33. The center hole 50 of the lever member 33 has a diameter that is smaller than that of inner end surfaces of the inner circumferential-direction members 41 of the detection target 21 in the radial direction.

Also, three arc holes 52 (hole portion) extending in arc shapes are open in the periphery of the center hole 50 in the lever member 33. As illustrated in FIGS. 8 and 9, the three arc holes 52 have substantially the same shapes and sizes as those of the inner circumferential-direction members 41 of the detection target 21 and are disposed at substantially the same positions as those of the inner circumferential-direction members 41 in the radial direction and the circumferential direction.

As illustrated in FIG. 5, the gear portion 31, the lever member 33, and the detection target 21 are integrated through insert molding working thereby to form the drive gear 15 that is one component. The gear portion 31 is formed of a resin by using the lever member 33 and the detection target 21 made of metal as insert articles. In other words, the lever member 33 and the detection target 21 are combined at the timing when the molding working of the gear portion 31 is completed.

As illustrated in FIG. 6, the valve shaft 10 is fixed to the drive gear 15 including the lever member 33 and the detection target 21 to thereby manufacture the valve shaft unit 30.

Specifically, one end of the valve shaft 10 is inserted into the shaft attachment hole 37 in the gear portion 31 of the drive gear 15, the one end of the valve shaft 10 is caused to abut the exposure portion 38 of the lever member 33 exposed from the shaft attachment hole 37, and the projecting portion 51 of the valve shaft 10 is inserted into the center hole 50 of the lever member 33, as illustrated in FIG. 7.

Then, the lever member 33 exposed to the inside of the outer hole 39 is irradiated with laser light from the outer surface side of the drive gear 15 to weld the lever member 33 and the valve shaft 10 as illustrated by the arrow in FIG. 7. Note that the position of the irradiation with the laser light is on the rear side of an abutting surface of the one end of the valve shaft 10 and the lever member 33, and it is desirable that welding be performed at three locations between the arc holes 52 of the lever member 33 and the center hole 50.

In this manner, the valve shaft unit 30 that includes the drive gear 15 including the lever member 33 and the detection target 21 and the valve shaft 10 is manufactured.

As illustrated in FIG. 10, the gear mold dies 60 and 61 support the lever member 33 and the detection target 21 when the drive gear 15 is formed through insert molding.

The gear mold dies 60 and 61 include a columnar lower mold die 60 having substantially the same shape as that of the one end of the valve shaft 10 and a columnar upper mold die 61 having a circular lower surface with a larger diameter than the outer shape of the inner circumferential-direction member 41.

The lower mold die 60 has a columnar shape that can be inserted into the shaft attachment hole 37 and has substantially the same diameter as that of the shaft attachment hole 37, and a projecting portion 62 with the same shape as that of the projecting portion 51 of the valve shaft 10 is formed on the upper surface thereof. Furthermore, protruding portions 63 having lateral sections with substantially the same shape as that of the arc holes 52 of the lever member 33 and protruding upward are included on the upper surface 60a of the lower mold die 60. Three protruding portions 63 are provided with respect to the projecting portion 62 to be aligned with the positions of the arc holes 52 in the radial direction with respect to the projecting portion 51 of the valve shaft 10. The upper surfaces of the protruding portions 63 are parallel with the upper surface 60a of the lower mold die 60.

When the drive gear 15 is formed through insert molding, the lever member 33 is placed on the upper surface 60a of the lower mold die 60. At this time, the projecting portion 62 of the lower mold die 60 is inserted into the center hole 50 of the lever member 33, and the protruding portions 63 of the lower mold die 60 are inserted into the arc holes 52 of the lever member 33. Furthermore, the inner circumferential-direction member 41 of the detection target 21 is placed on the upper surfaces 63a of the protruding portions 63 of the lower mold die 60. At this time, the inner circumferential-direction member 41 is installed such that three claw portions 43 of the detection target 21 pinch the outer surfaces of the three protruding portions 63.

Then, the inner space of a mold that is installed to cover the upper mold die 61 and the lower mold die 60 and is not illustrated is filled with a resin thereby to form the drive gear 15 including the lever member 33 and the detection target 21.

As described above, the drive gear 15 is fixed to the end of the valve shaft 10 to which the valve body 6 is fixed to transmit power from the electric motor 4 in the valve device 1 in the present embodiment.

In the present embodiment, the lever member 33 made of metal is included inside the gear portion 31 made of a resin in the drive gear 15 through insert molding. Also, the gear portion 31 includes the detection target 21 of the inductive sensor 20. The detection target 21 is also incorporated along with the lever member 33 when the gear portion 31 is manufactured. Therefore, the drive gear 15 integrated into the lever member 33 and the detection target 21 is manufactured as a component.

Also, the drive gear 15 is fixed to the valve shaft 10 by fixing the lever member 33 in the drive gear 15 having the lever member 33 and the detection target 21 to the end of the valve shaft 10 through laser welding.

Furthermore, the lever member 33 is provided with the arc holes 52 extending in the circumferential direction outside the position of welding with the end of the valve shaft 10 in the radial direction. In this manner, welding heat is unlikely to be transmitted from the welding portion on the radially inner side of the arc holes 52 to the radially outer side when the lever member 33 and the valve shaft 10 are laser-welded. Therefore, heat is unlikely to be transmitted to the gear portion 31 located further outward in the radial direction than the arc holes 52 when the lever member 33 and the valve shaft 10 are laser-welded, and it is possible to reduce thermal deformation of the gear portion 31.

Since the protruding portions 63 of the lower mold die 60 are inserted into the arc holes 52 of the lever member 33 at the time of the insertion molding working of the drive gear 15, the lever member 33 is positioned with respect to the lower mold die 60. It is thus possible to mold the drive gear 15 with the lever member 33 accurately positioned in the drive gear 15.

Also, the protruding portions 63 of the lower mold die 60 inserted into the arc holes 52 from the lower side at the time of the insert molding working are wall-shaped members that protrude upward through the lever member 33 and partition between the radially outer side and the radially inner side above the lever member 33. Therefore, it is possible to curb flowing of a resin to the radially inside by the protruding portions 63 when the gear portion 31 is molded through insert molding working.

In this manner, it is possible to prevent the resin from being present near the inner side of the arc holes 52 of the lever member 33 in the insert-molded drive gear 15, reduce a thermal influence on the resin portion when the lever member 33 and the valve shaft 10 are laser-welded, and to stabilize component quality of the drive gear 15.

Also, distal ends of the protruding portions 63 of the lower mold die 60 inserted into the arc holes 52 are configured to hold the detection target at the time of the insert molding working. Therefore, the detection target 21 is also positioned along with the lever member 33 with respect to the lower mold die 60. In this manner, it is possible to manufacture the high-quality drive gear 15 with the detection target 21 accurately positioned with respect to the gear portion 31 and the lever member 33.

Although the description of the embodiment has been provided hitherto, aspects of the present invention are not limited to the above embodiment. For example, detailed shapes of various components, such as the shape of the gear portion 31 of the drive gear 15, may be appropriately changed.

Also, although the present invention has been applied to a throttle valve in the above embodiment, it is possible to apply the present invention to various valve devices other than the throttle valve.

### REFERENCE SIGNS LIST

1 Valve device
6 Valve body
10 Valve shaft (shaft)
15 Drive gear (gear)
20 Inductive sensor (non-contact sensor)
21 Detection target
30 Valve shaft unit
33 Lever member (support member)
37 Shaft attachment hole (insertion hole)
38 Exposure portion
39 Outer hole (exposure hole)
52 Arc hole (hole portion)

What is claimed is:

1. A valve device comprising:
a plate-shaped gear made of a resin at one end of a shaft made of metal driving a valve body,
wherein the gear has a support member made of metal and integrated through insert molding in a state where at least a part of the support member is exposed in one side surface,
an exposure portion of the support member in the gear and the end of the shaft are welded to configure a shaft unit, and
the support member is provided with a hole portion extending in a circumferential direction on a radially outer side of a position of welding with the end of the shaft.

2. The valve device according to claim 1,
wherein the hole portion is a hole into which a protruding portion of a mold die of the gear is inserted such that the support member is held at the time of the insert molding working.

3. The valve device according to claim 2,
wherein the protruding portion protrudes on a distal side in an insertion direction through the support member and partitions between a radially outer side and a radially inner side of the protruding portion in a state the protruding portion is inserted into the hole portion at the time of the insert molding working.

4. The valve device according to claim 3,
wherein a detection target of a non-contact sensor detecting a rotation angle of the shaft is included on a side of the other side surface of the gear and the detection target is integrated into the gear along with the support member through the insert molding.

5. The valve device according to claim 4,
wherein the protruding portion of the mold die penetrating through the support member supports the detection target at the time of the insert molding working.

6. The valve device according to claim 1,
wherein the valve device is a throttle valve controlling an amount of air intake of an internal combustion engine.
